(19) United States
(12) Patent Application Publication
(10) Pub. No.: US 2009/0173902 A1
(43) Pub. Date: Jul. 9, 2009

(54) PRESSURIZED FLUID CONTROL DEVICE WITH A SAFETY CLOSURE FOR A COMPARTMENT CONTAINING THE PRESSURIZED FLUID

(76) Inventor: Luigi Ferrali, Firenze (IT)

Correspondence Address: MCGLEW & TUTTLE, PC, P.O. BOX 9227, SCARBOROUGH STATION, SCARBOROUGH, NY, 10510-9227, US

(21) Appl. No.: 12/282,690

(22) PCT Filed: Mar. 12, 2007
(86) PCT No.: PCT/IT2007/000179

§ 371 Date: Dec. 31, 2008

(30) Foreign Application Priority Data
Mar. 15, 2006 (IT) FI2006A000073

(51) Int. Cl. F16K 31/00

(52) U.S. Cl. 251/62

(57) ABSTRACT

The device comprises a body (3) defining a chamber (21 A, 21 B) sliding inside which is a control piston (5), which divides said chamber into a first half-chamber (21 B) and a second half-chamber (21A). A duct (33; 37) to feed a control fluid leads into each half-chamber; the first half-chamber has an opening (11), closable with a closing element (13), which is constrained to the body (3) by constraining means comprising: a first substantially annular seat (25), provided in a wall surrounding said opening (11); a second substantially annular seat (27) provided in the closing element (13); a filiform element (23) forming a blocking member of the closing element, and housed in a space defined by the two substantially annular seats.

### TECHNICAL FIELD

The present invention relates to a device or a system to block two mechanical elements with respect to each other, defined inside which is a compartment for pressurized fluid, which forces said two mechanical elements to move reciprocally away from each other.

More specifically, the present invention relates to improvements to a multiway valve with a control piston for valve switching, controlled by a pressurized fluid fed into one or other of two half-chambers delimited by the control piston, one of which has an opening leading to the external environment.

Valves of this type are used, for example, in purification plants or the like.

### STATE OF THE ART

In several applications in the hydraulic field it is necessary to close with a removable element a compartment of an appliance or device, inside which a pressure, which may even be high, can be established during operation.

For example, there are multiway hydraulic valves with a control device to switch the position of the valve, operated by a piston sliding inside a cylinder or chamber, divided into two half-chambers by said piston, into which half-chambers a pressurized control fluid (gaseous or liquid) is fed in a controlled way. The cylinder or chamber inside which the piston slides is closed by a closing element which is blocked inside an opening surrounded by a wall defining the chamber in which the piston slides. The closing element is removable, and can be removed, for example, for maintenance, to replace components or the like. Currently, blocking of the closing element takes place, for example, with a series of bolts to secure a flange. Alternatively, the closing element can be held in its seat by an elastic safety ring inserted axially (“Seeger ring”), which is housed in an annular seat provided in the wall surrounding the opening of the chamber in which the piston slides.

Currently known systems to block closing elements have some drawbacks, including: they are not easily removed; high stresses, even flexural stresses, are generated on the wall surrounding the opening with consequent difficulties in mechanical dimensioning; risks deriving from the fact that the blocking members of the closing element can be accidentally removed even when there is overpressure inside the compartment. When this occurs in a system where the control fluid is in gaseous state (i.e. air), the closing element without the blocking system, thrust by the pressure inside the pressurized compartment, can cause even serious damage to objects and persons.

### OBJECTS AND SUMMARY OF THE INVENTION

The object of the present invention is to provide a system for closing pressurized compartments, in particular to close chambers in which pistons slide to control multiway valves for hydraulic use, which overcomes entirely or in part the aforesaid drawbacks.

In substance, according to a first aspect the invention relates to a device operated by a pressurized control fluid, comprising a body defining a chamber, sliding inside which is a control piston, which divides said chamber into a first half-chamber and a second half-chamber. A duct to feed the control fluid leads into each of these half-chambers. At least the first half-chamber has an opening, closable with a closing element, for example to carry out maintenance. Constraining means, comprising a first substantially annular seat in a wall surrounding said opening and a second substantially annular seat in said closing element are provided to block the closing element. When the closing element is assembled to close said opening, the second substantially annular seat is positioned approximately coincident with the first substantially annular seat. A filiform element forming a blocking member of the closing element is housed in a space defined by the first substantially annular seat and by the second substantially annular seat and has a cross section configured and dimensioned to block said closing element. In practice, the filiform element projects from the first annular seat and interferes with the closing element so that it is housed (for the part projecting from the first annular seat) in the second annular seat produced in the closing element.

The device can in practice be a multiway valve, with switching of said valve controlled by said control piston.

Advantageously, according to a possible embodiment, when the closing element is in the position assembled in said opening, said filiform element cannot be removed. This is obtained with suitable dimensioning of the second annular seat and guarantees a high level of safety, as removal of the filiform blocking element is not possible unless the closing element is made to slide towards the inside of the mechanical member in the opening of which said closing element is inserted. However, this sliding towards the inside is only possible if the pressure inside the device is discharged. Ultimately, therefore, the closing element can only be removed in safe conditions, thereby preventing the risk of accidents caused by removal of the closing element when there is fluid (in particular a gaseous fluid) inside the volume closed by said element.

According to a possible embodiment, the second substantially annular seat is provided along a perimeter edge of the closing element, adjacent to an outer front wall thereof. According to an advantageous embodiment, this seat is preferably shaped like a chamfer of a corner of the closing element defined by the intersection between said front surface and a side surface of the closing element.

In a practical embodiment, the closing element can slide towards the inside of the half-chamber closed by said element, when a force that exceeds the force acting on said closing element from the inside of said half-chamber towards the outside is applied on said closing element from the outside towards the inside of said half-chamber, sliding of the closing element making the filiform element accessible.

Preferably, the wall surrounding the opening has a stop for the closing element, which limits the movement thereof towards the inside of said half-chamber.

The filiform element can have an annular shape, although it is preferably composed of a flexible rectilinear section comprising a first end and a second end, substantially abutting with each other when said filiform element is inserted in the substantially annular seats. In this way the cost of the filiform element is reduced substantially as it can be produced in the form of a continuous filament of considerable length, from which a piece of the required length is cut each time, said length being substantially the same as the extension of the annular seat in which it must be inserted. It would also be possible to insert more than one section in the same seat, i.e. to perform blocking with more than one filiform element.

In general the filiform element preferably has a cross section without corners, and preferably delimited by a convex line. For example, the filiform element can have an elliptical or preferably approximately circular cross section.

According to a preferred embodiment of the invention, the second substantially annular seat is delimited by an inclined surface so that a thrust is exerted on the filiform element towards the base of the first substantially annular seat, generated by the pressure inside said half-chamber. In general, the filiform element, the first substantially annular seat and the second substantially annular seat are preferably shaped so that the thrust generated on said closing element by the pressure inside generates on the filiform element a shearing and/or compressive stress, substantially without flexural stress.

Further advantageous features and embodiments of the device according to the invention are indicated in the appended claims and will be described in greater detail hereunder with reference to a non-limiting example of embodiment of the invention.

### BRIEF DESCRIPTION OF THE DRAWINGS

The invention will be better understood by following the description and accompanying drawing, which shows a non-limiting practical embodiment of the invention. More specifically, in the drawing:

FIG. 1 shows a front view of a multiway valve with a control device for switching of the valve with the closing element of the chamber in which the control piston slides in the assembled position;

FIGS. 2 to 7 show a longitudinal section according to II-II in FIG. 1 of the end part of the valve in various stages of the operation to open the chamber in which the control piston slides; and

FIG. 8 shows a longitudinal section of the body of the valve 1.

### DETAILED DESCRIPTION OF THE PREFERRED EMBODIMENT OF THE INVENTION

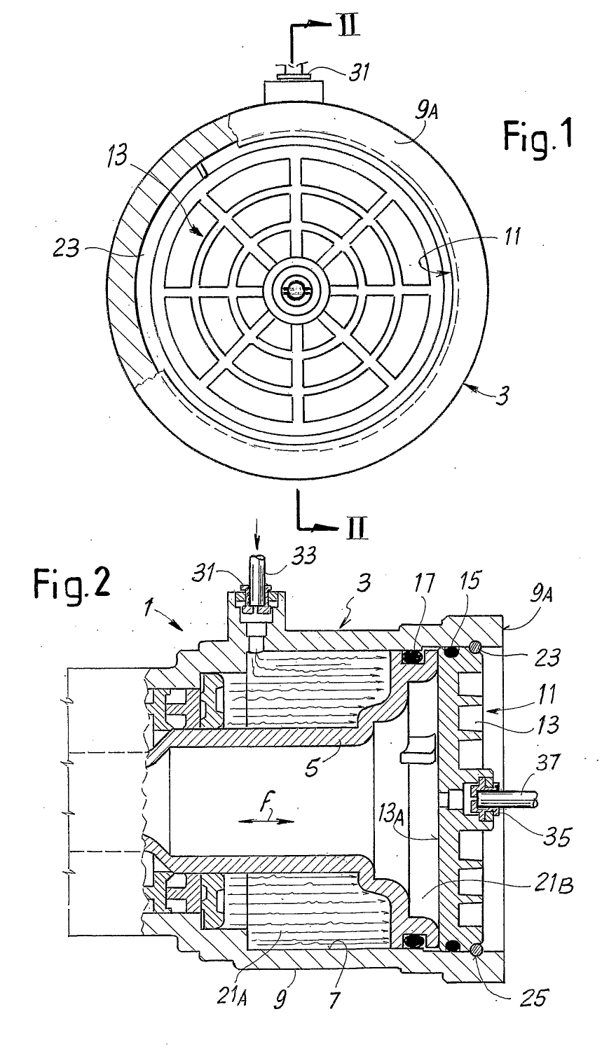

The accompanying FIGS. 1 to 7 show, limited to the end part in which the control piston is housed, a multiway valve 1 for hydraulic use with a switching system controlled by a double acting piston housed in the portion of the valve shown in FIGS. 1 to 7. The structure of the valve and of the switching device is known per se and not described in detail herein. FIG. 8 shows a complete longitudinal section of the body of the valve fitted to the base of 2 of a generic appliance which must be equipped with a valve of this type.

The numeral 3 indicates the end portion of the valve, housed slidingly inside which is a piston 5 to operate a sliding slide member (not shown) which opens and closes the various ports of the valve. The piston 5 is housed slidingly inside a cylindrical chamber 7 defined by a substantially cylindrical wall 9 forming part of the body of the valve 1.

The wall 9 ends with a front edge 9A surrounding an opening 11, which is closed by means of a closing element 13. The closing element 13 is equipped with an annular gasket 15, indicated schematically here as an O-ring, to maintain a seal between the closing element 13 and the inner surface of the wall 9. The piston 5 is also equipped with a gasket 17 on the inner surface of the cylindrical wall 9, again indicated schematically as O-ring.

The closing element 13 is stressed by the pressure existing in the compartment delimited by the inner surface 13A of the closing element 13 and by the piston. The mechanical thrust exerted by the piston 5 when a pressurized fluid contained in the half-chamber 21A located on the opposite side of the piston 5 with respect to the closing element 13 acts thereon can be added to the stresses generated by the pressure existing in this compartment. In the drawing the numeral 21B indicates the second half-chamber, into which the piston 5 divides the inner volume 7 of the cylinder inside which said piston slides.

To block the closing element 13 against the thrust applied thereon from the inside the cylindrical body of the valve, a filiform element 23 is provided housed in a first substantially annular seat 25, provided in proximity to the edge 9A on the inner surface of the cylindrical wall 9. The filiform element 23 is composed of a section of line which, in the example illustrated, has a circular cross section. The length of this section of line is substantially the same as the circumferential extension of the first substantially annular seat 25. It would also be possible to use several portions of a filiform element.

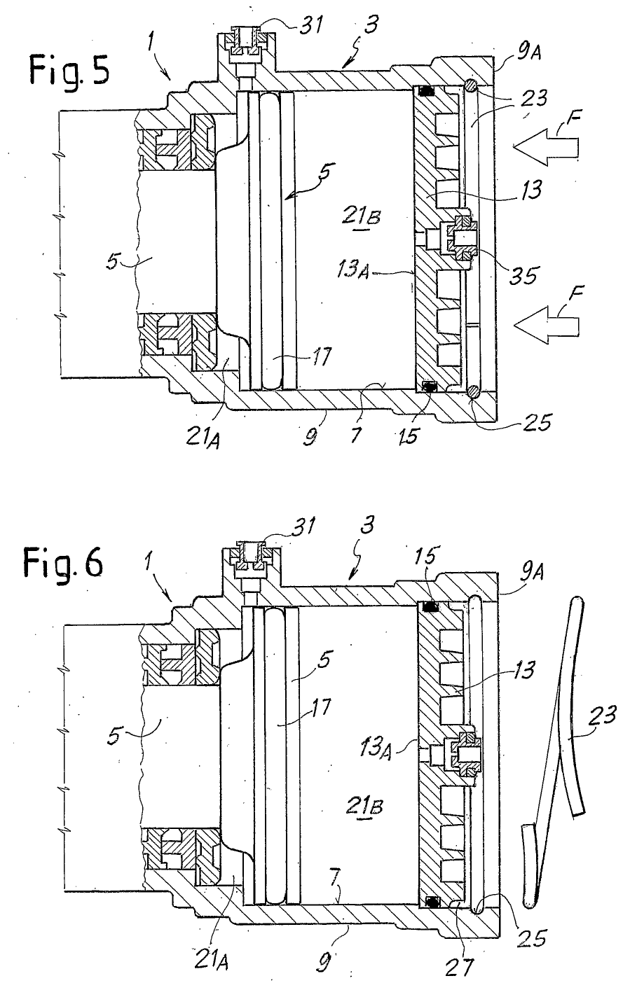

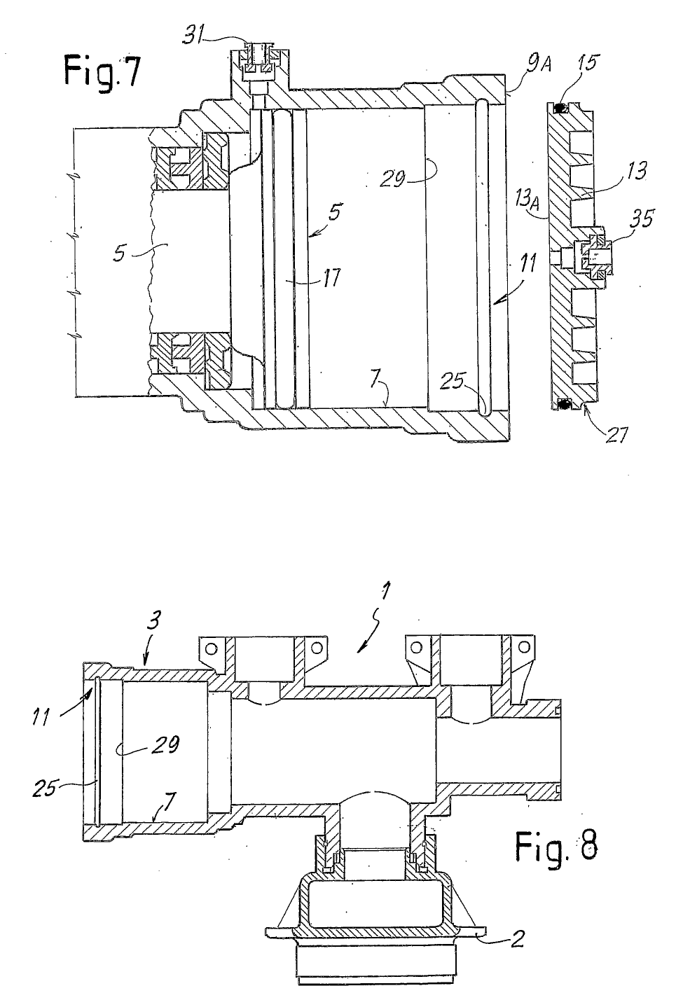

The filiform element 23 projects for approximately half of the cross section thereof from the first substantially annular seat 25 to form a stop to prevent removal of the closing element 13 from the cylindrical body. Along the perimeter extension of the closing element 13, in proximity to the outer surface thereof, a second substantially annular seat 27 is provided (see FIGS. 6 and 7), inside which the filiform element 23 projects when the closing element 13 is assembled.

The substantially annular seat 27 can have an approximately tapered surface, or in any case a surface which is inclined with respect to the axis of symmetry of said seat. Said surface transfers the thrust stress to which the closing element 13 is subjected to the filiform element 23, so that a substantially or mainly radial stress, and consequently compressive stress, acts on the cross section of the filiform element 23. As well as this compressive stress, the filiform element 23 is also subjected to shearing stress. In substance, the second substantially annular seat 27 is open on the cylindrical perimeter surface of the closing element 13 and on the front surface thereof, and in practice forms a suitably shaped chamber of the edge delimited in the area of intersection between the front wall and the side wall of the closing element 13.

In general, the shape of the substantially annular seats 25 and 27 and the dimension and shape of the cross section of the filiform element 23 are such that the thrust exerted thereon by the closing element 13 substantially generates no flexural stresses on the material forming the cylindrical wall 9 or in any case only very limited flexural stresses.

Provided on the inner surface of the cylindrical wall 9, inside the compartment in which the piston 5 slides, is a stop or annular shoulder 29, which is arranged in an inner position which is located towards the inside with respect to the inner surface 13A of said closing element 13, when the closing element 13 is in the assembled position (FIG. 2).

The movement of the piston 5 in the direction of the double arrow f (FIG. 2) is controlled by feeding a pressurized fluid into the cylindrical chamber in which said piston slides. For this purpose a first connector 31 for connection to a flexible pipe 33 of a pressurized control fluid is provided on the cylindrical wall 9. A second connector 35 for a second flexible pipe 37 for the pressurized control fluid is provided in a substantially central position of the closing element 13. The two flexible pipes 33 and 35 feed the pressurized control fluid into the two half-chambers 21A and 21B into which the piston 5 divides the volume inside the wall 9.

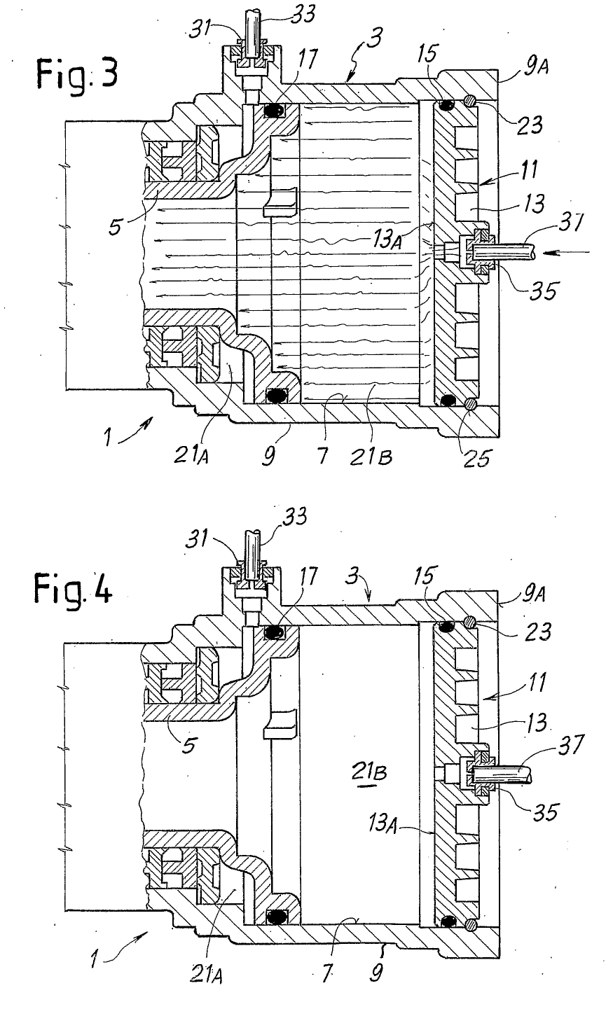

FIG. 2 shows a condition in which the resultant of the pressure on the piston 5 exerted by the fluid fed through the pipe 33 is greater than the resultant of the pressure acting on the opposite face of said piston, which will consequently press against the closing element 13. FIG. 3 shows the position taken by the piston 5 when instead it is thrust in the opposite direction by a prevalent pressure on the feed side of the fluid from the pipe 37.

Irrespective of the position of the piston 5, pressure is applied during operation of the valve on the inner face 13A of the closing element 13, the resultant of which thrusts the closing element 13 against the filiform blocking element 23. In these conditions, as the filiform element 23 is not accessible from the outside, being embedded in the annular seats 25 and 27, it is not possible to remove the closing element 13.

In order to remove the closing element 13, and thus allow access to the inside of the body of the valve 1, the operations shown schematically in the sequence in FIGS. 4 to 7 must be performed. In substance, after having moved the piston 5 away from the closing element 13 the pressure inside the chamber in which the piston 5 slides is discharged, if necessary disconnecting the pipes 33 and 37. In these conditions, no force acts on the inner face of the closing element 13A and it is therefore possible, with a thrusting action from outside according to the arrow F (FIG. 5), to move the closing element 13 towards the inside of the wall 9 until it abuts against the annular shoulder 29.

The shoulder 29 is at a distance from the first substantially annular seat 25 so that when the closing element 13 is abutting against the shoulder 29, the substantially annular seat 25 is accessible from the outside, so that with a suitably shaped tool (e.g. even a simple screwdriver or punch) the operator can detach the filiform element 23 from the substantially annular seat 25 to remove it (FIG. 6).

When the filiform element 23 has been removed from its seat 25, the closing element 13 can be extracted through the opening 11. FIG. 7 shows the final stage of this operation with the closing element 13 removed from the body of the valve.

It is understood from the illustration above that numerous advantages are attained with the closing arrangement obtained through the filiform element 23, the closing element 13 and the substantially annular seats 25, 27. In the first place flexural stresses on the material of the cylindrical wall 9 coincident with the seat 25 are reduced substantially or even eliminated. Moreover, stable and reliable blocking of the closing element 13 is obtained with an extremely inexpensive element like the filiform element 23, which can, for example, be made of a suitable synthetic material such as Nylon® or the like, which can be applied without the aid of any tools and removed with the use of a simple screwdriver or other pointed tool. Moreover, the arrangement described above allows an important advantage to be attained in terms of safety: the closing element 13 cannot be removed while internal pressure is acting thereon. Only when the pressure in the inner compartment (in this case delimited by the cylindrical wall 9, by the piston 5 and by the closing element 13) has been taken to the value of the outside ambient pressure can the closing element 13 be moved against the stop or shoulder 29 and therefore the filiform blocking element 23 is not accessible to be removed.

It is understood that the drawing only shows a possible embodiment of the invention, which can vary in forms and arrangements, without however departing from the scope of the concept underlying the invention, as better specified in the claims below. Any reference numerals in the appended claims are provided purely to facilitate reading thereof in the light of the above description and accompanying drawings and do not in any way limit the scope of protection defined thereby.

1. A device operated by a pressurized control fluid, the device comprising:
a control piston;
a closing element;
a body defining a chamber, said chamber receiving said control piston such that said control piston is slidable within said chamber, said control piston dividing said chamber into a first half-chamber and a second half-chamber;
a duct for feeding said control fluid leading into each of said half-chambers; wherein at least the first half-chamber has an opening, closable with said closing element;
a constraining means for constraining said closing element to said body, said constraining means comprising:
a first substantially annular seat provided in a wall surrounding said opening;
a second substantially annular seat provided in said closing element, said second substantially annular seat being positioned approximately coincident with said first substantially annular seat when said closing element closes said opening;
a filiform element forming a blocking member of the closing element, said filiform element being housed in a space defined by said first substantially annular seat and said second substantially annular seat and having a cross section configured and dimensioned to block said closing element.

2. A device according to claim 1, wherein the device forms a multiway valve, wherein switching of said valve is controlled by said control piston.

3. A device according to claim 1, wherein said filiform cannot be removed when said closing element is an assembled position in said opening.

4. A device according to claim 2, wherein said second substantially annular seat is provided along a perimeter edge of said closing element, adjacent to an outer front wall of said closing element.

5. A device according to claim 4, wherein said second substantially annular seat is shaped like a chamfer of a corner of the closing element, said second substantially annular seat being defined by an intersection between said front surface and a side surface of the closing element.

6. A device according to claim 1, wherein said closing element slides with respect to the body towards the inside of said first half-chamber, when a first force is applied to said closing element from a position located outside of said closing element toward the inside of said half-chamber such that the filiform element is accessible, said first force being greater than a force acting on said closing element from inside said half-chamber.

7. A device according to claim 6, wherein the wall surrounding the opening has a stop for said closing element, which limits movement thereof towards the inside of said half-chamber.

8. A device according to claim 1, wherein said filiform element comprises a first end and a second end, substantially abutting with each other when said filiform element is inserted in said first and second substantially annular seats.

9. A device according to claim 1, wherein said filiform element has a cross section without corners.

10. A device according to claim 1, wherein said filiform element has a cross section delimited by a closed curved line, defining a convex profile, said cross section being one of a substantially elliptical cross section and a substantially circular cross section.

11. A device according to claim 1, wherein said second substantially annular seat is delimited by an inclined surface such that pressure inside one of said half-chambers generates a thrust, said thrust exerting pressure on said filiform element towards the base of said first substantially annular seat.

12. A device according to claim 1, wherein said first and said second annular seat have a substantially circular extension.

13. A device according to claim 1, wherein said filiform element, said first substantially annular seat and said second substantially annular seat are shaped such that pressure inside one of said half chambers generates a thrust on said closing element, said thrust generating a shearing and/or compressive stress on said filiform element, substantially without flexural stress.

14. A device according to claim 13, wherein said first substantially annular seat, said filiform element and said second substantially annular seat are shaped such that pressure inside one of said half chambers generates a thrust generated on said closing element, said thrust generating stresses on the sides of the first substantially annular seat stresses with a negligible flexural component.

15. A device according to claim 1, further comprising a seal between said closing element and the wall surrounding said opening.

16. A device according to claim 1, wherein the duct to feed the control fluid to said first half-chamber is connected to said closing element.

17. A device according to claim 1, wherein said constraining means comprises another filiform blocking element of said closing element.

18. A device according to claim 2, wherein said filiform cannot be removed when said closing element is an assembled position in said opening.

19. A device according to claim 1, wherein said second substantially annular seat is provided along a perimeter edge of said closing element, adjacent to an outer front wall of said closing element.

20. A device according to claim 2, wherein said closing element slides with respect to the body towards the inside of said first half-chamber when a first force is applied to said closing element from a position located outside of said closing element toward the inside of said half-chamber such that the filiform element is accessible, said first force being greater than a force acting on said closing element from inside said half-chamber.
